(19) United States
(12) Patent Application Publication
(10) Pub. No.: US 2014/0201841 A1
(43) Pub. Date: Jul. 17, 2014

(54) Client Security Scoring

(71) Applicants: Nikhil M. Deshpande, Beaverton, OR (US); Krvstof Zmudzinski, Forest Grove, OR (US); Danald S. Gardner, Mountain View, CA (US)

(72) Inventors: Nikhil M. Deshpande, Beaverton, OR (US); Krvstof Zmudzinski, Forest Grove, OR (US); Danald S. Gardner, Mountain View, CA (US)

(21) Appl. No.: 13/976,511

(22) PCT Filed: Mar. 30, 2012
(86) PCT No.: PCT/US12/31694

§ 371 Date: Jun. 27, 2013

(51) Int. Cl. G06F 21/57

(52) U.S. Cl. CPC G06F 21/577
USPC 726/25

(57) ABSTRACT

Methods, apparatuses and techniques for security evaluation. A security profile of a client device is evaluated. The security profile is based on hardware and software security mechanism utilization of the client device. A security score is generated based on the security profile. The security score is provided to a service provider.

### TECHNICAL FIELD

Embodiments of the invention relate to secure transactions. More particularly, embodiments of the invention relate to techniques for evaluation of mobile devices for secure transactions.

### BACKGROUND

Currently, remote client devices are deemed untrustworthy by service providers (e.g., cloud service providers), for example, financial institutions, retail sites, etc. With this assumption, emphasis is placed on back-end infrastructure for detecting anomalous activity, fraudulent activity, etc. This results in complex and inefficient mechanisms that are implemented because the service provider cannot trust the mobile device. This may lead to a high number of false positives that can hamper legitimate user experiences.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of a system in which a client security score may be utilized.

FIG. 2 is a block diagram of one embodiment of an electronic system.

FIG. 3 is a flow diagram of one embodiment for a technique to generate a security score.

FIG. 4 is a flow diagram of one embodiment of a technique for providing a security score service.

FIG. 5 is a block diagram of one embodiment of a security score agent.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Described herein are mechanisms to assess a client security profile and create a client security score to assist service providers in determining a trust level that should be allocated to the client device. In one embodiment the security score is provided to a service provider that may use the security score to determine the level of trust and/or verification that may be assigned to the client device.

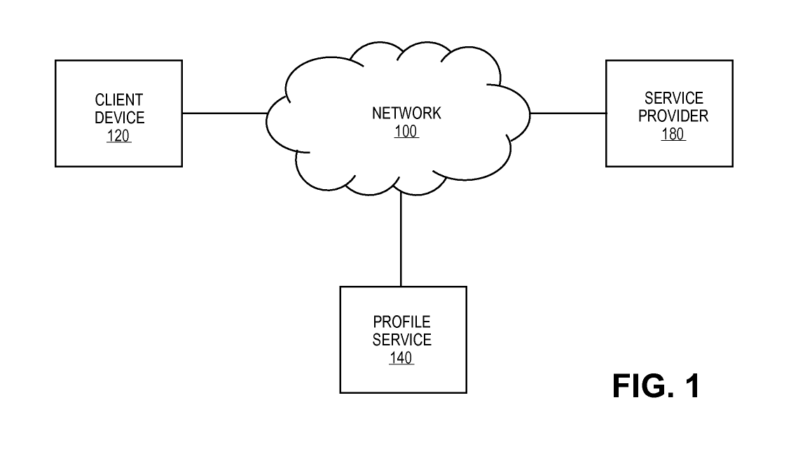

FIG. 1 is a block diagram of one embodiment of a system in which a client security score may be utilized. The example of FIG. 1 is only a simple example, any number of client devices, service provider and/or profile evaluators may be supported.

Network 100 may be any type of network or combination of networks that allow electronic devices to be interconnected and communicate. Network 100 can be the internet and/or other smaller networks (e.g., corporate networks, home networks) that a user of a device may utilize to access a service provider.

Client device 120 may be any type of electronic system that allows a user to access a service provider over network 100. Client device 120 may be, for example, a mobile computing device, a smart phone, a tablet, a desktop computer system, a satellite or cable decoder box, etc.

In one embodiment, profile service 140 operates to determine a security profile of client device 120. Profile service 140 may communicate with client device 120 directly and/or via network 100. Profile service 140 obtains information from client device 120 to determine a security score.

Service provider 180 may be any type of entity that provides a service to client device 120 that is accessed in a secure manner. For example, service provider 180 may be a banking web site, or a travel arrangement web site, or a medical service/records provider, or any other type of service provider where communications between client device 120 and service provider 180 have some level of security.

In one embodiment, at some point in time, which may be before, after and/or during a secure transaction, profile service 140 communicates with client device 120 to gather profile and security information related to the operation of client device 120. Some relevant factors are listed here and others are listed below. Any number of considerations and evaluations may be involved in the security score generation process.

A few examples of the types of things that may be considered when generating the security score include a rating of security features that are built into the hardware on the device, a number or rate of transactions from the device, an unusual number or rate of transactions, a location history of the device, a browsing behavior of the device, whether the device has accessed any known “risky” resources, whether security mechanisms are being (e.g., secure enclaves, sandboxes) applied to applications corresponding to the service provider, whether software security mechanisms are applied to the client device, how recently the security information has been gathered. Many other factors may be considered. The score could also be computed based on how the device is protected. For example, if the user uses his fingerprint to unlock the device as opposed to a simple 4-digit code, the score could be higher. Also, if the user puts the device to sleep instead of shutting it down or hibernating, the score could be lower since in sleep mode the data on the disk are not encrypted when whole-disk encryption is used.

Based on information gathered from client device 120, profile service 140 may generate a security score for client device 120. This security score may be provided to client device 120 and/or to service provider 180. Conceptually, the security score can be considered similar to a credit score for an individual. Various factors can be taken into consideration to develop and score security risk or worthiness. A service provider can utilize the security score to, for example, determine what types of security mechanisms should be employed and/or what level of trust should be attributed to client device 120. The security score can be any type of indicator of device trustworthiness, for example, a number, a color, a letter, etc.

Service provider 180 can then provide services in accordance with policies developed based on security goals and guidelines for the service being provided. Different service providers may utilize security scores differently, just as different creditors utilize personal credit scores differently.

In one embodiment, service profile 140 is an independent third party not associated with either client device 120 or service provider 180. By being an independent third party, profile service 140 may provide an objective evaluation of the security profile of client device 120. Also, profile service 140 may provide a more rapid response to security risks than a system in which security updates or changes must be applied directly to each client device.

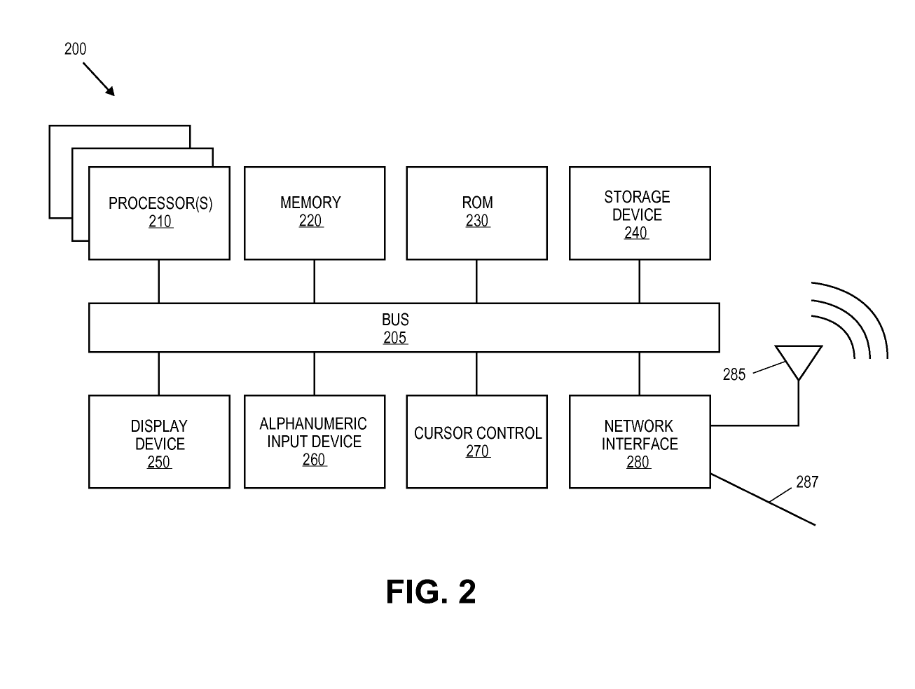

FIG. 2 is a block diagram of one embodiment of an electronic system. The electronic system illustrated in FIG. 2 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components. The electronic system of FIG. 2 may represent any of the electronic systems of FIG. 1.

Electronic system 200 includes bus 205 or other communication device to communicate information, and processor 210 coupled to bus 205 that may process information. While electronic system 200 is illustrated with a single processor, electronic system 200 may include multiple processors and/or co-processors. Electronic system 200 further may include random access memory (RAM) or other dynamic storage device 220 (referred to as main memory), coupled to bus 205 and may store information and instructions that may be executed by processor 210. Main memory 220 may also be used to store temporary variables or other intermediate information during execution of instructions by processor 210.

Electronic system 200 may also include read only memory (ROM) and/or other static storage device 230 coupled to bus 205 that may store static information and instructions for processor 210. Data storage device 240 may be coupled to bus 205 to store information and instructions. Data storage device 240 such as a magnetic disk or optical disc and corresponding drive may be coupled to electronic system 200.

Electronic system 200 may also be coupled via bus 205 to display device 250, such as a cathode ray tube (CRT) or liquid crystal display (LCD), to display information to a user. Alphanumeric input device 260, including alphanumeric and other keys, may be coupled to bus 205 to communicate information and command selections to processor 210. Another type of user input device is cursor control 270, such as a mouse, a trackball, or cursor direction keys to communicate direction information and command selections to processor 210 and to control cursor movement on display 250.

Electronic system 200 further may include network interface(s) 280 to provide access to a network, such as a local area network. Network interface(s) 280 may include, for example, a wireless network interface having antenna 285, which may represent one or more antenna(e). Network interface(s) 280 may also include, for example, a wired network interface to communicate with remote devices via network cable 287, which may be, for example, an Ethernet cable, a coaxial cable, a fiber optic cable, a serial cable, or a parallel cable.

In one embodiment, network interface(s) 280 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 280 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

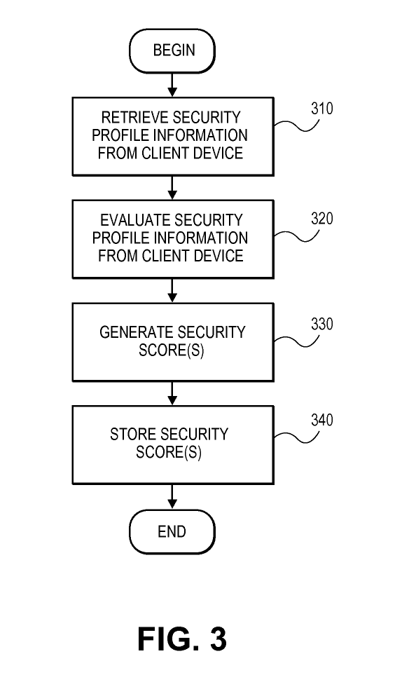

FIG. 3 is a flow diagram of one embodiment for a technique to generate a security score. In one embodiment, the operations of FIG. 3 are performed by a security profile entity/service (e.g., 140 in FIG. 1), which can be one or more devices. In alternate embodiments, multiple entities can be involved in providing the security score.

Security information is retrieved from the client device, 310. This can be, for example, part of a registration process, either explicit or implicit. Gathering of security information can be periodic or can happen only in response to specific events, for example, requests to access a service provider.

The security profile service/entity evaluates the security information gathered from the client device, 320. This evaluation can utilize any of the factors discussed herein as part of the security evaluation process. A security score is generated as part of the evaluation, 330. In one embodiment, the security score is a number on a predetermined scale; however, more complex security scores can also be supported. The security score is stored for later use, 340.

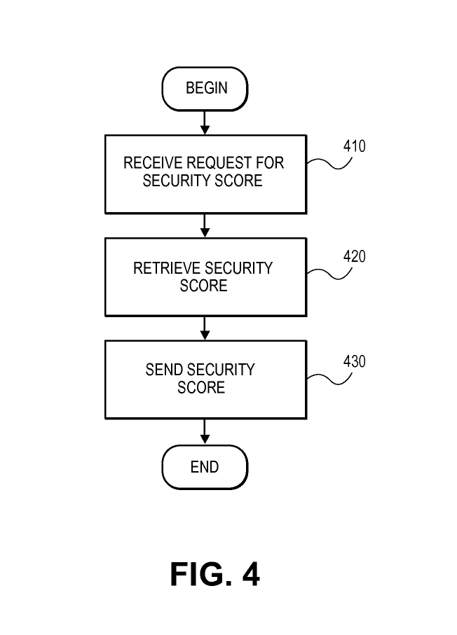

FIG. 4 is a flow diagram of one embodiment of a technique for providing a security score service. In one embodiment, the operations of FIG. 3 are performed by a security profile entity/service (e.g., 140 in FIG. 1), which can be one or more devices. In alternate embodiments, multiple entities can be involved in providing the security score.

A request for a security score is received, 410. In one embodiment, this request is received from a service provider (e.g., 180 in FIG. 1); however, other entities can also request security score information. The request can be received in any manner known in the art.

The security score is retrieved, 420. In one embodiment, retrieving the security score involves retrieving a previously generated security score from a memory of an electronic device. In some embodiments, this security score may be updated or otherwise reevaluated. If a security score does not exist for the requested client, a security score can be generated, for example, by using the technique of FIG. 3.

The security score is transmitted to the requesting entity, 430. Alternatively, the security score can be transmitted to an entity designated in the request for the security score. Sending the security score can be accomplished in any manner known in the art.

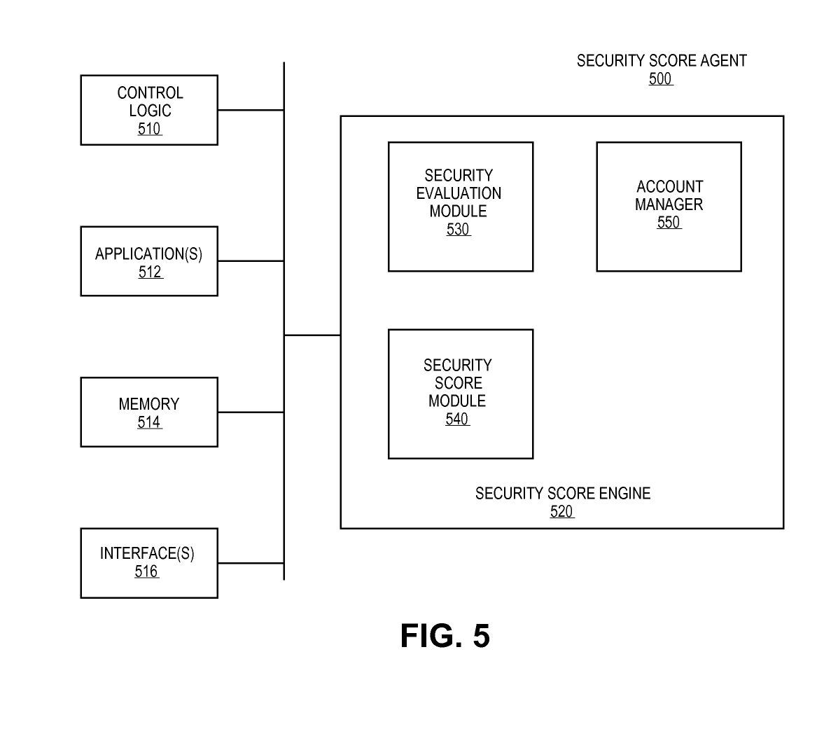

FIG. 5 is a block diagram of one embodiment of a security score agent. The security score agent may be resident within, for example, a security score server application, an electronic system providing a security score, or a combination thereof. Security score agent 500 includes control logic 510, which implements logical functional control to direct operation of security score agent 500, and/or hardware associated with directing operation of security score agent 500. Logic may be hardware logic circuits and/or software routines. In one embodiment, security score agent 500 includes one or more applications 512, which represent code sequence and/or programs that provide instructions to control logic 510.

Security score agent 500 includes memory 514, which represents a memory device and/or access to a memory resource for storing data and/or instructions. Memory 514 may include memory local to security score agent 500, as well as, or alternatively, including memory of the host system on which security score agent 500 resides. Security score agent 500 also includes one or more interfaces 516, which represent access interfaces to/from (e.g., an input/output interface, application programming interface) security score agent 500 with regard to entities (electronic or human) external to security score agent 500.

Security score agent 500 also includes security score engine 520, which represents one or more functions that enable security score agent 500 to provide the functionality described herein. Example modules that may be included in security score engine 520 are security evaluation module 530, security score module 540 and account manager 550. Each of these modules may further include other modules to provide other functions. As used herein, a module refers to routine, a subsystem, etc., whether implemented in hardware, software, firmware or some combination thereof.

Security evaluation module 530 operates to gather security information from one or more client devices to gather the type of information to be utilized to generate a security score. The information can be gathered in response to a request for a security score or over a period of time.

Security score module 540 operates to generate a security score from the security information. The security score provides an indication of the security profile of the corresponding client device. In one embodiment, the security score is a number; however, other security scores may be provided. For example, the security score may be a set of “grades” in different categories corresponding to security/risk categories for the client device. Other security scores may also be supported.

Account manager 550 may operate to manage and coordinate the flow of security score information between client devices and service providers. For example, different levels of accounts may be available to service providers to request different types of security scores with different levels of information. Similarly, different levels of accounts may be available to client devices to provide different types of security information with different levels of privacy.

Various techniques for utilizing security scoring are described herein, including utilization of a non-transitory computer-readable medium. A security profile of a client device is evaluated. The security profile is based on hardware and software security mechanism utilization of the client device. A security score is generated based on the security profile. The security score is provided to a service provider.

The security score can be provided by an independent third party not affiliated with the client device or the service provider. The security score can be generated by an independent third party not affiliated with the client device or the service provider. The hardware utilization can include determining whether the client device is utilizing embedded hardware security mechanisms. The security profile can include a geographical location history of the client device.

The security profile can include an evaluation of current client transaction requests with historical client transaction requests. The security profile can include a comparison of a current client transaction with calendar activities corresponding to a user of the client device. Evaluating a security profile of a client device can be based on hardware and software utilization of the client device is performed by an agent resident on the client device. The agent can be protected by a hardware security mechanism.

A security provider may include a memory to store instructions and a processor coupled with the memory. The processor executes instructions stored in the memory. The instructions cause the apparatus to receive from a client device hardware and software utilization information, to evaluate the information from the client device and to generate a security score based on the information. The apparatus further provides the security score to one or more service providers.

The security score can be provided by an independent third party not affiliated with the client device or the service provider. The security score can be generated by an independent third party not affiliated with the client device or the service provider. The hardware utilization can include determining whether the client device is utilizing embedded hardware security mechanisms. The security profile can include a geographical location history of the client device.

The security profile can include an evaluation of current client transaction requests with historical client transaction requests. The security profile can include a comparison of a current client transaction with calendar activities corresponding to a user of the client device. Evaluating a security profile of a client device can be based on hardware and software utilization of the client device is performed by an agent resident on the client device. The agent can be protected by a hardware security mechanism.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A method comprising:
evaluating a security profile of a client device, wherein the security profile is based on hardware and software security mechanism utilization of the client device;
generating a security score based on the security profile; and
providing the security score to a service provider.

2. The method of claim 1 wherein the security score is provided by an independent third party not affiliated with the client device or the service provider.

3. The method of claim 1 wherein the security score is generated by an independent third party not affiliated with the client device or the service provider.

4. The method of claim 1 wherein the hardware utilization comprises determining whether the client device is utilizing embedded hardware security mechanisms.

5. The method of claim 1 wherein the security profile comprises a geographical location history of the client device.

6. The method of claim 1 wherein the security profile comprises an evaluation of current client transaction requests with historical client transaction requests.

7. The method of claim 1 wherein the security profile comprises a comparison of a current client transaction with calendar activities corresponding to a user of the client device.

8. The method of claim 1 wherein evaluating a security profile of a client device, wherein the security profile is based on hardware and software utilization of the client device is performed by an agent resident on the client device.

9. The method of claim 8 wherein the agent is protected by a hardware security mechanism.

10. The method of claim 1 wherein evaluating a security profile of a client device, wherein the security profile is based on hardware and software utilization of the client device is performed by a third party entity coupled with the client device.

11. A non-transitory computer-readable medium having stored there on instructions that, when executed by one or more processors, cause the one or more processors to:
evaluate a security profile of a client device, wherein the security profile is based on hardware and software utilization of the client device;
generate a security score based on the security profile; and
provide the security score to a service provider.

12. The medium of claim 11 wherein the security score is provided by an independent third party not affiliated with the client device or the service provider.

13. The medium of claim 11 wherein the security score is generated by an independent third party not affiliated with the client device or the service provider.

14. The medium of claim 11 wherein the hardware utilization comprises determining whether the client device is utilizing embedded hardware security mechanisms.

15. The medium of claim 11 wherein the security profile comprises a geographical location history of the client device.

16. The medium of claim 11 wherein the security profile comprises an evaluation of current client transaction requests with historical client transaction requests.

17. The medium of claim 11 wherein the security profile comprises a comparison of a current client transaction with calendar activities corresponding to a user of the client device.

18. The medium of claim 11 wherein evaluating a security profile of a client device, wherein the security profile is based on hardware and software utilization of the client device is performed by an agent resident on the client device.

19. The medium of claim 18 wherein the agent is protected by a hardware security mechanism.

20. The medium of claim 11 wherein evaluating a security profile of a client device, wherein the security profile is based on hardware and software utilization of the client device is performed by a third party entity coupled with the client device.

21. An apparatus comprising:
a memory to store instructions;
a processor coupled with the memory, the processor to execute instructions stored in the memory, the instructions to cause the apparatus to receive from a client device hardware and software utilization information, to evaluate the information from the client device and to generate a security score based on the information, the apparatus further to provide the security score to one or more service providers.

22. The apparatus of claim 21 wherein the apparatus corresponds to an independent third party not affiliated with the client device or the service provider.

23. The apparatus of claim 21 wherein the hardware utilization comprises determining whether the client device is utilizing embedded hardware security mechanisms.

24-26. (canceled)

27. The apparatus of claim 21 wherein evaluating a security profile of a client device, wherein the security profile is based on hardware and software utilization of the client device is performed by an agent resident on the client device.

28. (canceled)

29. The apparatus of claim 21 wherein evaluating a security profile of a client device, wherein the security profile is based on hardware and software utilization of the client device is performed by a third party entity coupled with the client device.
